(19) United States
(12) Patent Application Publication
(10) Pub. No.: US 2025/0279946 A1
(43) Pub. Date: Sep. 4, 2025

(54) FINGERPRINTING METHOD AND APPARATUS FOR NETWORK FORENSIC OF IN-VEHICLE INFOTAINMENT ENVIRONMENT

(71) Applicant: AJOU UNIVERSITY INDUSTRY-ACADEMIC COOPERATION FOUNDATION, Suwon-si (KR)

(72) Inventors: Taeshik SHON, Gyeonggi-do (KR); Yeonghun SHIN, Gyeonggi-do (KR)

(73) Assignee: AJOU UNIVERSITY INDUSTRY-ACADEMIC COOPERATION FOUNDATION, Suwon-si (KR)

(21) Appl. No.: 19/062,816

(22) Filed: Feb. 25, 2025

(30) Foreign Application Priority Data
Feb. 29, 2024 (KR) 10-2024-0029785

(51) Int. Cl. H04L 43/062; G01S 5/02; H04L 43/02; H04L 43/065

(52) U.S. Cl. CPC H04L 43/062; G01S 5/0252; H04L 43/02; H04L 43/065

(57) ABSTRACT

A system includes: a communication interface connected to another computing device and receiving an input related to information about a grammar to be searched; and at least one processor configured to obtain a query including information about the grammar to be searched based on the received input, compare grammar structure information corresponding to the grammar included in the obtained query with sentence structure information of each sentence stored in a database, and obtain a search result including at least one sentence having the grammar structure information according to a comparison result, wherein the grammar structure information and the sentence structure information include structure information based on dependency parsing.

### CROSS-REFERENCE TO RELATED APPLICATION

This application claims the benefit of Korean Patent Applications No. 10-2024-0029785, filed on Feb. 29, 2024, in the Korean Intellectual Property Office, the disclosures of which are incorporated herein in its entirety by reference.

### BACKGROUND

### 1. Field

The present disclosure relates to a fingerprinting method and apparatus for network forensic of an in-vehicle infotainment environment.

Example embodiments of the present disclosure relate to a national research and development project. Information on the national research and development project has subject identification No. 1711170476, subject No. 2022-0-01022, project name “Development of core information security technology”, and subject title “Development of Collection and Integrated Analysis Methods of Automotive Inter/Intra System Artifacts through Construction of Event-based experimental system”.

### 2. Description of the Related Art

An in-vehicle infotainment system refers to an in-vehicle system that provides a driver and passengers with information and entertainment functions, and typical examples include Android Auto and Apple CarPlay. Through these systems, various functions can be provided including not only basic functions such as navigation, music playback, and call functions, but also checking vehicle status information and app linkage.

The in-vehicle infotainment system is connected to a smartphone to configure one environment, and provides various convenience services to a driver through this connection. The driver can use infotainment services such as Android Auto or Apple CarPlay connected via Wi-Fi and Bluetooth, or use infotainment services provided by vehicle manufacturers through Bluetooth connection only. As vehicles and smartphones are connected to provide services, various network communications occur between vehicles and smartphones, and vehicle environments are increasingly exposed to cyber security threats. However, conventional technology makes it difficult to perform sufficient post-analysis of these threats.

In addition, conventional vehicle forensic technology is difficult to apply to a wireless communication-based vehicle infotainment environment because the conventional technology analyzes data based on physical storage. Conventional digital forensic technology for vehicle infotainment environments is mostly based on data obtainable from physical storage of investigation target devices, and even when based on network communication, the technology is limited to simple network communication data collection methods and fails to derive additional information using collected information.

Meanwhile, according to Korean Patent Publication No. 10-2014-0074518, a vehicle digital forensic analysis system and method is disclosed, which collects and analyzes information stored in a vehicle's ECU using an OBD-II interface. However, conventional digital forensic technology for vehicles mostly acquires information stored in ECU through OBD-II interface, which has a limitation in that it cannot be applied to network communication of vehicle infotainment environments.

### SUMMARY

One or more embodiments include a fingerprinting method and apparatus for acquiring basic knowledge for network forensic of a vehicle infotainment environment.

One or more embodiments include a method and apparatus for performing fingerprinting on data types occurring according to vehicle type and connected terminal type, and for quickly identifying an attacker's terminal in case of a network attack on a vehicle infotainment environment in the future based on the fingerprinting.

Additional aspects will be set forth in part in the description which follows and, in part, will be apparent from the description, or may be learned by practice of the presented embodiments of the disclosure.

According to an aspect of an embodiment, a method of fingerprinting for network forensic of an in-vehicle infotainment environment comprises collecting network communication of the in-vehicle infotainment environment; analyzing the collected network communication of the in-vehicle infotainment environment; deriving a fingerprint of the in-vehicle infotainment environment; and analyzing the network communication of the in-vehicle infotainment environment based on the derived fingerprint.

According to an exemplary embodiment, the network communication comprises at least one of Wi-Fi or Bluetooth.

According to an exemplary embodiment, collecting the network communication of the in-vehicle infotainment environment comprises determining whether the network communication is Wi-Fi communication; collecting Wi-Fi channel communication when the network communication is Wi-Fi communication; and collecting Bluetooth channel communication when the network communication is not Wi-Fi communication, or when the network communication is Wi-Fi communication and the Wi-Fi channel communication has been collected.

According to an exemplary embodiment, a terminal connected to the in-vehicle infotainment environment includes an Android terminal or an iOS terminal.

According to an exemplary embodiment, in collecting the network communication of the in-vehicle infotainment environment, for the Android terminal, an HCI Snoop Log function supported by Android operating system is used for collecting Bluetooth communication data, and for the iOS terminal, a PacketLogger tool provided by XCode is used for collecting Bluetooth communication data.

According to an exemplary embodiment, analyzing the collected network communication of the in-vehicle infotainment environment comprises determining whether the network communication is Wi-Fi communication; and analyzing additional identification information related to Wi-Fi when the network communication is Wi-Fi communication.

According to an exemplary embodiment, analyzing the collected network communication of the in-vehicle infotainment environment comprises acquiring identification information through a network communication analysis tool including Wireshark.

According to an exemplary embodiment, identification information acquired by analyzing the collected network communication of the in-vehicle infotainment environment comprises identification information on connected terminal and identification information on the in-vehicle infotainment system.

According to an exemplary embodiment, the identification information on the connected terminal comprises at least one of IMEI, ISMI, Model, Vendor, Bluetooth ID, Wi-Fi SSID, Wi-Fi password, used service, used function, used protocol and Port number.

According to an exemplary embodiment, the identification information on the in-vehicle infotainment system comprises at least one of Model, Vendor, Bluetooth ID, Wi-Fi SSID, Wi-Fi PW, used protocol and Port number.

According to an exemplary embodiment, deriving the fingerprint of the in-vehicle infotainment environment comprises analyzing the identification information on the in-vehicle infotainment system; analyzing the identification information on the connected terminal; analyzing service identification information; analyzing detailed function usage content; and generating a network fingerprint.

According to an exemplary embodiment, analyzing the network communication of the in-vehicle infotainment environment based on the derived fingerprint comprises inputting network communication data; comparing and analyzing data based on the network fingerprint; identifying vehicle type and manufacturer; identifying the connected terminal and manufacturer of the connected terminal; identifying used service; and identifying detailed function usage content.

According to an exemplary embodiment, identification information of the fingerprinted in-vehicle infotainment system comprises at least one of information on category, infotainment system, platform, wireless connection, wireless connection with external device, packet acquisition status and vehicle data acquisition status, and identification information of a terminal to be connected to the fingerprinted in-vehicle infotainment system comprises at least one of information on manufacturer, device name, OS and version and infotainment system.

According to an aspect of an embodiment, a non-transitory computer-readable storage medium storing one or more programs comprises instructions for performing the above-described method.

According to an aspect of an embodiment, an apparatus comprises one or more processors; and a non-transitory computer-readable storage medium storing one or more programs configured to be executed by the one or more processors, wherein the one or more programs comprise instructions for performing the above-described method.

### BRIEF DESCRIPTION OF THE DRAWINGS

Embodiments of the disclosure will be more clearly understood from the following detailed description taken in conjunction with the accompanying drawings in which:

FIG. 1 is a schematic view illustrating an in-vehicle infotainment environment according to an exemplary embodiment.

FIG. 2 is a schematic block diagram illustrating a hardware configuration of an electronic device included in a fingerprinting system for network forensic of an in-vehicle infotainment environment according to an exemplary embodiment.

FIG. 3 is a flowchart for explaining a network forensic method according to an exemplary embodiment.

FIG. 4 is a flowchart for explaining a network communication collection step of the in-vehicle infotainment environment in FIG. 3.

FIG. 5 is a flowchart for explaining an analysis step of the collected network communication and a fingerprint derivation step of the in-vehicle infotainment environment in FIG. 3.

FIG. 6 is a flowchart for explaining a step of analyzing network communication of the in-vehicle infotainment environment based on network fingerprint in FIG. 3.

FIG. 7A is a view illustrating an example of a fingerprinted in-vehicle infotainment system according to an exemplary embodiment.

FIG. 7B is a view illustrating an example of terminals to be connected to a fingerprinted in-vehicle infotainment system according to an exemplary embodiment.

FIG. 8 is a view illustrating identification information collected from network communication of an in-vehicle infotainment environment according to an exemplary embodiment.

### DETAILED DESCRIPTION

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that the disclosure will be thorough and complete, and will fully convey the scope of the inventive concept to one of ordinary skill in the art.

It will be understood that, although the terms first, second, etc. may be used herein to describe various members, regions, layers, sections, and/or components, these members, regions, layers, sections, and/or components should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of this disclosure, a first component may be named as a second component, and a second component may be named as a first component.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

The terms “unit”, “device”, “˜er (˜or)”, “module”, etc., refer to a processing unit of at least one function or operation, which may be implemented by hardware such as a processor, a microprocessor, an application processor, a micro controller, a central processing unit (CPU), an application processor (AP), a graphics processing unit (GPU), an accelerate processor unit (APU), a digital signal processor (DSP), an application specific integrated circuit (ASIC), a field programmable gate array (FPGA), a neural processing unit (NPU), a neuromorphic processor, etc., software, or a combination of hardware and software, and may be implemented in a form combined with a memory that stores data necessary for processing at least one function or operation.

Throughout the specification, components may be discriminated by their major functions. For example, two or more components as herein used may be combined into one, or a single component may be subdivided into two or more sub-components according to subdivided functions. Each of the components may perform its major function and further perform part or all of a function served by another component. In this way, part of a major function served by each component may be dedicated and performed by another component.

As used herein, the term “and/or” includes any and all combinations of one or more of the associated listed items.

Hereinafter, embodiments of the inventive concept will be described in detail with reference to the accompanying drawings.

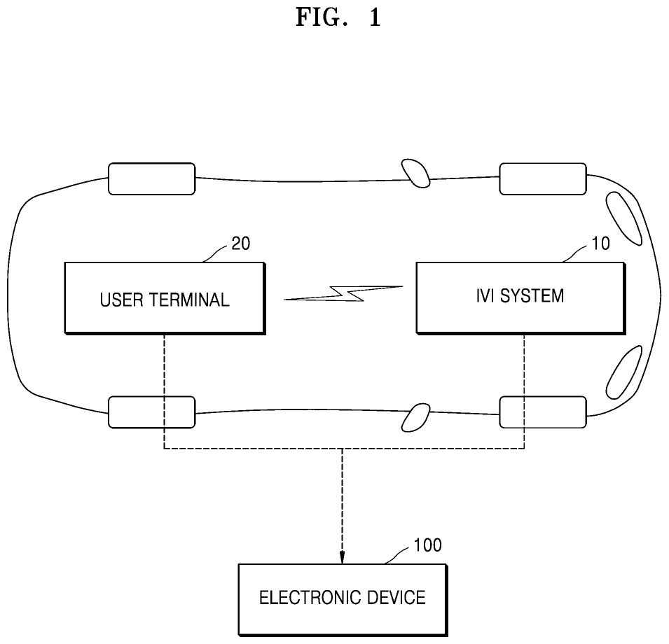

FIG. 1 is a schematic view illustrating an in-vehicle infotainment environment according to an exemplary embodiment.

Referring to FIG. 1, the in-vehicle infotainment environment includes an in-vehicle infotainment system 10 (hereinafter, referred to as “IVI system 10”) and a user terminal 20.

According to an exemplary embodiment of the present disclosure, the IVI system 10 is an integrated system that provides various functions to vehicle drivers by combining information, which means necessary information such as road driving conditions and route guidance, and entertainment, which means various entertainment and human-friendly functions.

According to an exemplary embodiment of the present disclosure, the user terminal 20 is a mobile device used by a vehicle driver and/or passenger, and can be implemented as a smartphone, laptop, tablet PC, or the like.

As vehicles provide various services to drivers, network communication between vehicles and terminals is increasing. Accordingly, vehicle environments are becoming increasingly exposed to cyber security threats, and there is a lack of measures to derive meaningful digital forensic evidence based on information collected by analyzing network communication of vehicle infotainment environments. For example, when security elements such as authentication or encryption are not applied to vehicle wireless communication, an attacker can easily modify messages, and such modifications are difficult to detect.

Accordingly, as driver's personal information or the vehicle environment itself can be exposed to cyber security threats, research is needed on methods of performing fingerprinting for forensic in network of vehicle infotainment environments in case of cyber attacks and crimes against vehicles.

Additionally, when a user terminal 20 that communicates with a vehicle or the vehicle's IVI system 10 becomes a subject of investigation such as being used in a crime, research is needed on methods of performing digital forensic to enable investigation agencies to collect information exchanged between the IVI system 10 and user terminal 20 and information stored in each device.

According to an exemplary embodiment of the present disclosure, an electronic device 100 is a device that performs digital forensic on a vehicle infotainment environment, and may be implemented as a smartphone, laptop, tablet, computer, server, or the like. Meanwhile, the electronic device 100 can also be implemented as a user terminal 20.

According to an exemplary embodiment of the present disclosure, a fingerprinting method for network forensic of a vehicle infotainment environment can help digital forensic investigation by enabling quick identification of an attacker's terminal when cyber attacks targeting vehicle networks occur, thereby rapidly identifying the attacker's attack protocol and services used for the attack.

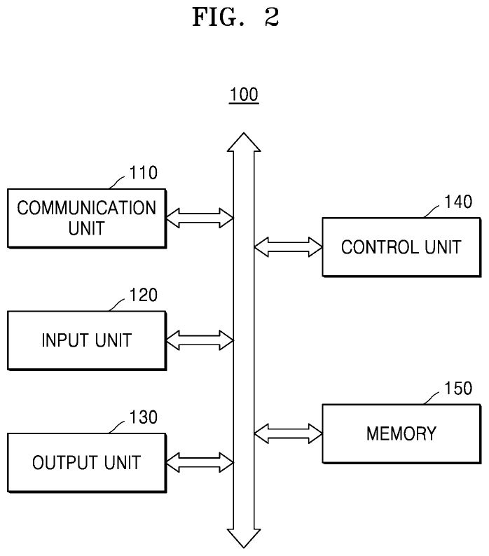

FIG. 2 is a schematic block diagram illustrating a hardware configuration of an electronic device included in a fingerprinting system for network forensic of an in-vehicle infotainment environment according to an exemplary embodiment.

The hardware configuration of the electronic device 100 shown in FIG. 2 may correspond to the hardware configuration of the electronic device shown in FIG. 1. Referring to FIG. 2, the electronic device 100 may include a communication unit 110, an input unit 120, an output unit 130, a control unit 140, and a memory 150. The configuration shown in FIG. 2 is an example for convenience of explanation, and the electronic device 100 may include more or fewer components than those shown in FIG. 2.

The communication unit 110 may include one or more communication modules that enable communication with other terminals or servers by connecting the electronic device 100 to a network. For example, the communication modules may include mobile communication modules such as LTE, 5G, wireless communication modules such as Wi-Fi, Bluetooth, and/or various other wired or wireless communication modules.

The input unit 120 is a component for acquiring information such as user input, video, and audio, and may include various input means such as mechanical/electronic input means, cameras, microphones, and the like.

The output unit 130 is for providing information to users by generating outputs related to visual, auditory, or tactile senses, and may include displays, speakers, vibration modules, and the like.

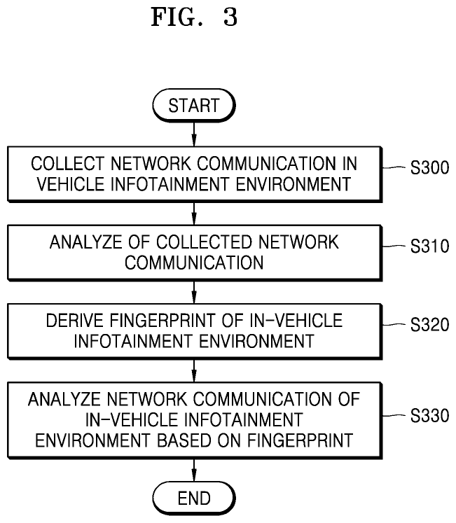

The control unit 140 may control overall operations of the electronic device 100. The control unit 140 may process signals, data, information, etc. that are input or output through the above-described components, or provide certain information or functions according to various applications or algorithms stored in the memory 150. For example, the control unit 140 may correspond to a component that substantially performs the steps described later in FIG. 3. This control unit 140 may include at least one processor and/or at least one programmable circuit. For example, the control unit 140 may be implemented with hardware such as CPU, AP (application processor), MCU, GPU, NPU, integrated circuit, ASIC, FPGA, etc.

The memory 150 may store programs and data necessary for operation of the electronic device 100. Additionally, the memory 150 may store data generated or acquired through the control unit 140. The memory 150 may be configured with storage media or combinations of storage media such as ROM, RAM, flash memory, SSD, HDD, etc.

FIG. 3 is a flowchart for explaining a network forensic method according to an exemplary embodiment.

Hereinafter in this specification, it is assumed that the above-described fingerprinting and network forensic are performed in the electronic device 100. However, the fingerprinting may be performed in the user terminal 20 and/or the IVI system 10 instead of the electronic device 100.

In step S300, all network communications occurring in the vehicle infotainment environment may be collected. Generally, network communication channels in the vehicle infotainment environment are Wi-Fi and Bluetooth, and when using platforms such as Android Auto or Apple CarPlay, both channels are used. In the case of basic connection methods provided by vehicle manufacturers, only the Bluetooth channel is used. The method of collecting network communication differs depending on the terminal connected to the vehicle.

For Android terminals, the HCI Snoop Log function supported by the Android operating system is used for collecting Bluetooth communication data. For Wi-Fi communication data collection, various network communication analysis tools including Wireshark may be used.

The HCI Snoop Log function is a basic function supported by the Android operating system, which can be accessed in the settings-developer mode-HCI Snoop Log menu. The HCI Snoop Log function is a tool that can be used for debugging and troubleshooting by recording detailed information about Bluetooth communication, diagnosing Bluetooth communication problems, identifying root causes of various problems such as connection issues, data loss, error messages, and analyzing all details of the communication process including HCI commands and events, HCI packets, L2CAP packets, and RFCOMM packets. Additionally, the HCI Snoop Log function may perform protocol compatibility verification, identify protocol compatibility issues between Android devices and other Bluetooth devices, detect protocol standard violations and solve problems, and analyze Bluetooth performance, where it may measure and analyze performance by measuring Bluetooth communication speed, latency, packet loss rate, etc., identify causes of performance degradation and seek improvement measures, and utilize HCI commands and events analysis for developing new Bluetooth functions.

Wireshark is a powerful open source tool for analyzing network traffic that may be used by various users such as developers, network administrators, and security experts for network troubleshooting, protocol analysis, security vulnerability diagnosis, and other purposes.

For iOS terminals, a PC using macOS is required for collecting Bluetooth or Wi-Fi communication data. A virtual hardware interface for the iOS terminal must be registered on the PC using macOS. After that, the PacketLogger tool provided by XCode is used for collecting Bluetooth communication data. For Wi-Fi communication data collection, various network communication analysis tools may be used, same as with Android.

In step S310, analysis of the collected network communication may be performed.

Through the analysis, various identification information about the vehicle or connected terminal may be acquired. Various network communication analysis tools including Wireshark may be used for analysis. Through analysis of the collected communication, identification information on the connected terminal (IMEI, ISMI, Model, Vendor, Bluetooth ID, Wi-Fi SSID, Wi-Fi PW, used service, used function, used protocol and Port number, etc.) may be acquired. Additionally, identification information on the vehicle infotainment system (Model, Vendor, Bluetooth ID, Wi-Fi SSID, Wi-Fi PW, used protocol and Port number, etc.) may be acquired.

In step S320, a fingerprint may be derived based on various identification information acquired in the analysis step S310.

Various identification information combinations are used to derive the fingerprint. The main fingerprints to be derived are exemplified below.
1. Vehicle type and manufacturer identification (based on identification information such as Model, Vendor, Bluetooth ID, Wi-Fi SSID, etc.)
2. Connected terminal and manufacturer identification (based on identification information such as Model, Vendor, Bluetooth ID, etc.)—For terminals, identification of owners, etc. is possible based on IMEI and IMSI
3. Used service identification (based on communication channel, used protocol, Port number)
4. Detailed function usage content identification (based on communication channel, used protocol, Port number, communication related to the function)

In step S330, network communication of the vehicle infotainment environment may be analyzed based on the fingerprint derived in the fingerprinting derivation step S320. The analysis of network communication in the vehicle infotainment environment may be performed by a vehicle infotainment environment network communication analysis device, which may be the electronic device 100 in FIG. 1.

The vehicle infotainment environment network communication analysis device may receive network communication logs or packet data based on the derived fingerprint and perform analysis and derivation of vehicle type, connected terminal, each manufacturer, used service, and/or detailed function usage content. The device has combinations and types of identification information for analyzing each fingerprint received and stored through prior analysis, and may perform comparison and analysis on the input data.

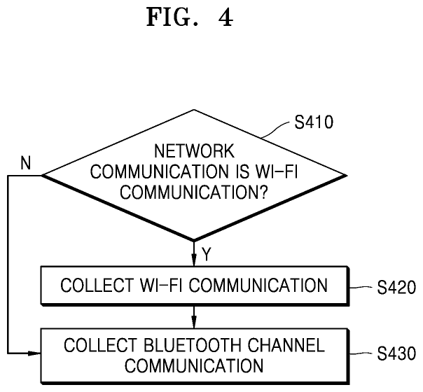

FIG. 4 is a flowchart for explaining the network communication collection step of the in-vehicle infotainment environment according to FIG. 3.

The network communication collection step S300 of the in-vehicle infotainment environment may include the step S410 of determining whether the network communication is Wi-Fi communication, the step S420 of collecting Wi-Fi communication when the network communication is Wi-Fi communication, and the step S430 of collecting Bluetooth channel when the network communication is not Wi-Fi communication or when the Wi-Fi communication has been collected.

When the network communication is not Wi-Fi communication, the Bluetooth channel may be collected, therefore the Bluetooth channel is always collected for communication.

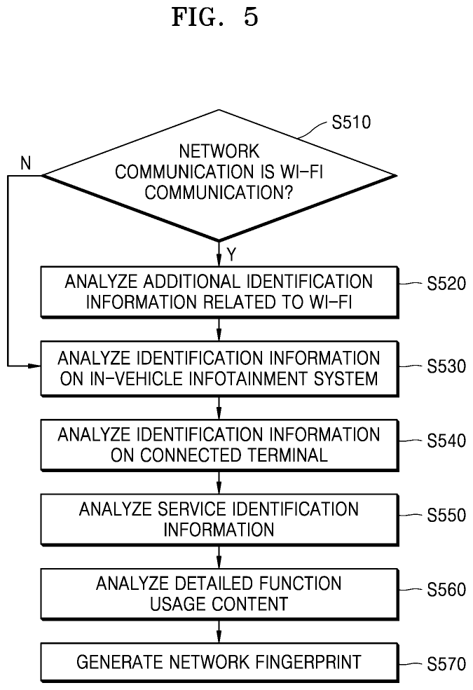

FIG. 5 is a flowchart for explaining the analysis step of the collected network communication S310 and the fingerprint derivation step of the in-vehicle infotainment environment S320 according to FIG. 3.

The step of performing analysis on the collected network communication S310 may include the step S510 of determining whether the network communication is Wi-Fi communication, and the step S520 of analyzing additional identification information related to Wi-Fi when the network communication is Wi-Fi communication.

Through analysis of the collected communication, identification information on the connected terminal (IMEI, ISMI, Model, Vendor, Bluetooth ID, Wi-Fi SSID, Wi-Fi PW, used service, used function, used protocol and Port number, etc.) may be acquired. Additionally, identification information on the vehicle infotainment system (Model, Vendor, Bluetooth ID, Wi-Fi SSID, Wi-Fi PW, used protocol and Port number, etc.) may be acquired.

The fingerprint derivation step S320 of the in-vehicle infotainment environment may include the step S530 of analyzing identification information on the vehicle infotainment system, the step S540 of analyzing identification information on the connected terminal, the step S550 of analyzing service identification information, the step S560 of analyzing detailed function usage content, and the step S570 of generating a network fingerprint.

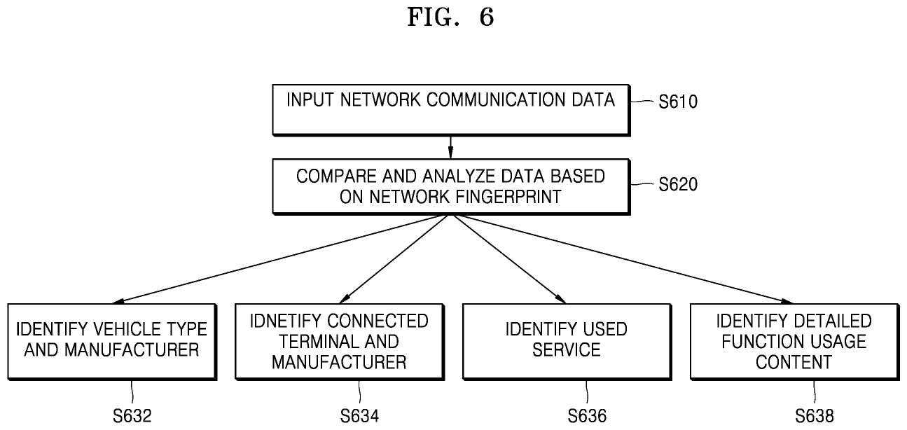

FIG. 6 is a flowchart for explaining the step of analyzing network communication of the in-vehicle infotainment environment based on network fingerprint according to FIG. 3.

The step S330 of analyzing network communication of the in-vehicle infotainment environment based on network fingerprint may include the step S610 of inputting network communication data, the step S620 of comparing and analyzing data based on network fingerprint, the step S632 of identifying vehicle type and manufacturer, the step S634 of identifying connected terminal and manufacturer, the step S636 of identifying used service, and the step S638 of identifying detailed function usage content.

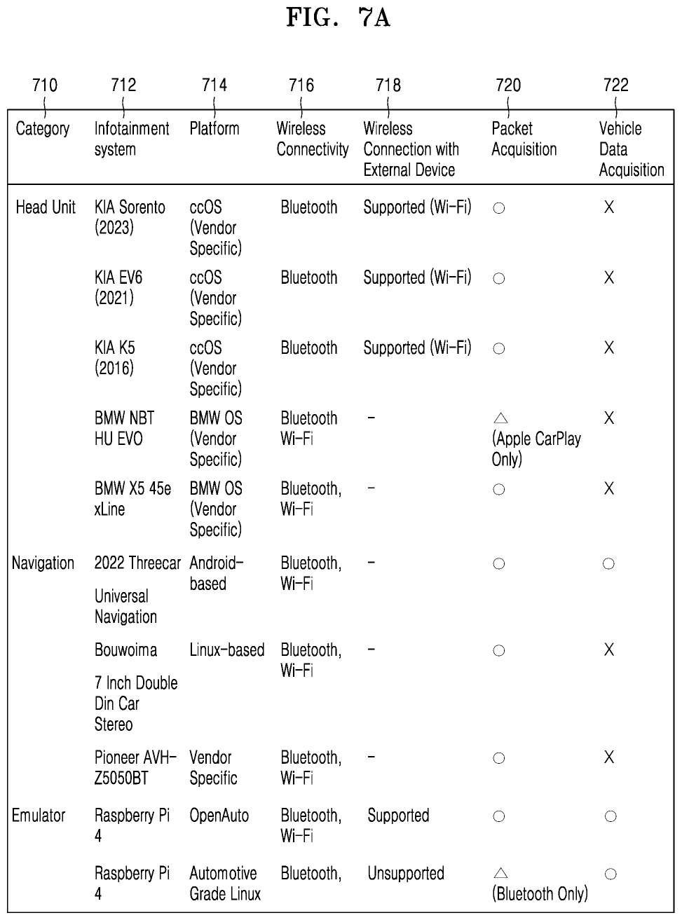

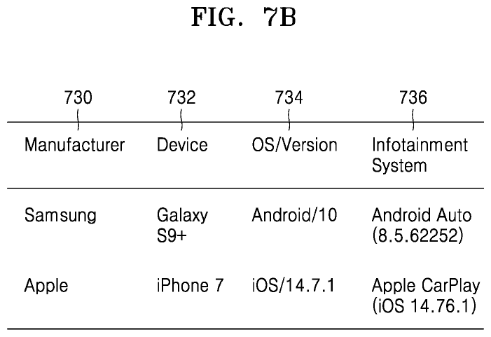

FIG. 7A is a view illustrating an example of a fingerprinted in-vehicle infotainment system according to an exemplary embodiment.

For the fingerprinted in-vehicle infotainment system, information on category 710, infotainment system 712, platform 714, wireless connection 716, wireless connection with external device 718, packet acquisition status 720 and vehicle data acquisition status 722 may be identified.

For example, in the head unit category 710, the infotainment system 712 of KIA's 2023 Sorento is identified, ccOS is identified as the platform 714, wireless connection 716 via Bluetooth and Wi-Fi support for wireless connection with external device 718 are identified, and information indicating that packets are acquired 720 but vehicle data is not acquired 722 may be identified.

FIG. 7B is a view illustrating an example of terminals to be connected to a fingerprinted in-vehicle infotainment system according to an exemplary embodiment.

For terminals to be connected to the fingerprinted in-vehicle infotainment system, information on manufacturer 730, device name 732, OS and version 734, and infotainment system 736 may be acquired.

For example, the manufacturer 730 may be identified as Samsung, the device name 732 of the terminal to be connected may be identified as Galaxy S9+, the OS and version 734 may be identified as Android version 10, and the infotainment system 736 may be identified as Android Auto (8.5.62252).

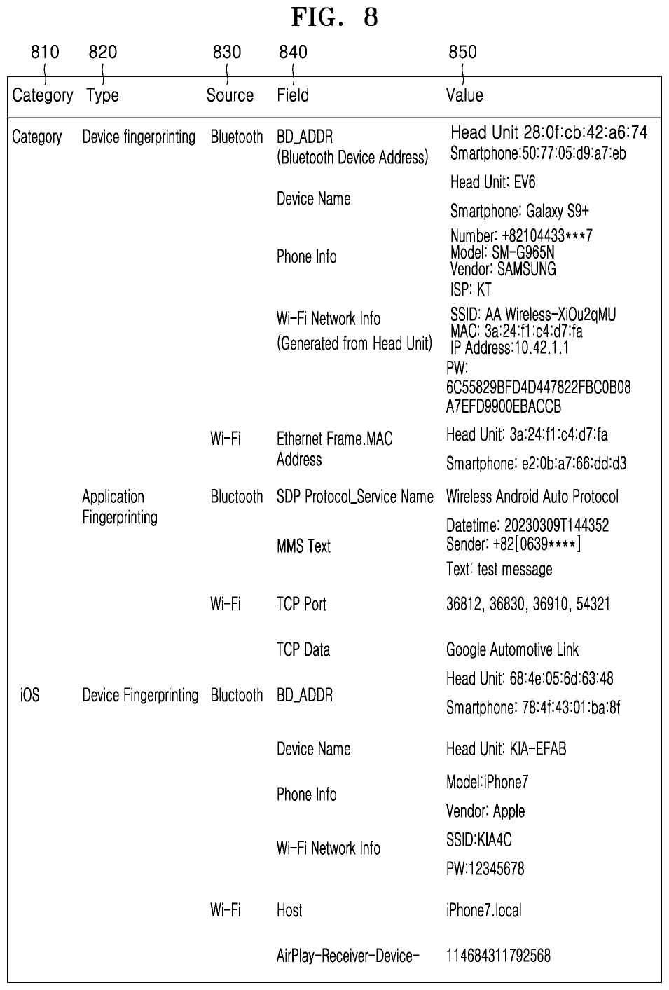

FIG. 8 is a view illustrating identification information collected from network communication of an in-vehicle infotainment environment according to an exemplary embodiment.

The identification information collected from network communication of the in-vehicle infotainment environment according to an exemplary embodiment of the present disclosure may include category 810, type 820, source 830, field 840, and value 850.

For example, the identification information collected from network communication of the in-vehicle infotainment environment may include Android as category 810, device fingerprinting as type 820, Bluetooth as source 830, BD_ADDR (Bluetooth Device Address) as field 840, and “Head Unit: 28:0f:cb:42:a6:74” as value 850.

The present disclosure may acquire basic knowledge for vehicle identification, manufacturer identification, and connected device identification by collecting and analyzing network communication data of the vehicle infotainment environment. The identification information collected from network communication of the vehicle infotainment environment may enable quick identification of an attacker's terminal when an attack occurs on the vehicle infotainment environment in the future.

According to an exemplary embodiment of the present disclosure, by collecting and analyzing network communication data of an in-vehicle infotainment environment, basic knowledge for identifying vehicles, manufacturers, and connected devices can be acquired, and the information obtained through this can be utilized when an attack occurs on the in-vehicle infotainment environment in the future.

According to an exemplary embodiment of the present disclosure, when a network-based attack occurs on an in-vehicle infotainment system, by analyzing communication logs and packets stored in the in-vehicle infotainment system, a device that performed the attack can be identified based on previously fingerprinted information. When cyber attacks targeting vehicle networks occur in the future, quick identification of the attacker's terminal enables rapid identification of the attacker's attack protocol and services used for the attack, which can assist in digital forensic investigation.

Moreover, current vehicle digital forensic conventional technology is limited to ECU and in-vehicle storage devices, and while some conventional technology exists for network communication of vehicle infotainment environments, it is limited to simple communication data collection and analysis. In a situation where vehicle infotainment environments in which a driver's terminal is connected and operates with a vehicle are being rapidly applied to daily life, and countermeasures against possible cyber attacks targeting these environments are needed, according to an exemplary embodiment of the present disclosure, this can be applied to most vehicles where infotainment systems are used.

Effects obtainable by the inventive concept are not limited to the effects described above, and other effects not described herein may be clearly understood by one of ordinary skill in the art to which the disclosure belongs from the above description.

The embodiments described above may be implemented as computer-readable code on a program-recorded medium. The non-transitory computer-readable medium includes all types of recording devices that store data that can be read by a computer system. Examples of the non-transitory computer-readable medium include HDD, SSD, silicon disk drive (SDD), ROM, RAM, compact disc-read only memory (CD-ROM), magnetic tape, floppy disk, optical data storage device, etc.

While the disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the disclosure.

What is claimed is:

1. A method of fingerprinting for network forensic of an in-vehicle infotainment environment, the method comprising:
collecting network communication of the in-vehicle infotainment environment;
analyzing the collected network communication of the in-vehicle infotainment environment;
deriving a fingerprint of the in-vehicle infotainment environment; and
analyzing the network communication of the in-vehicle infotainment environment based on the derived fingerprint.

2. The method of claim 1, wherein the network communication includes at least one of Wi-Fi communication or Bluetooth communication.

3. The method of claim 2, wherein collecting the network communication of the in-vehicle infotainment environment comprises:
determining whether the network communication is Wi-Fi communication;
collecting Wi-Fi channel communication in case of the network communication is Wi-Fi communication; and
collecting Bluetooth channel communication when the network communication is not Wi-Fi communication, or when the network communication is Wi-Fi communication and the Wi-Fi channel communication has been collected.

4. The method of claim 3, wherein a terminal connected to the in-vehicle infotainment environment includes an Android terminal or an iOS terminal.

5. The method of claim 4, wherein in collecting the network communication of the in-vehicle infotainment environment,
for the Android terminal, an HCI Snoop Log function supported by Android operating system is used for collecting Bluetooth communication data, and
for the iOS terminal, a PacketLogger tool provided by XCode is used for collecting Bluetooth communication data.

6. The method of claim 5, wherein analyzing the collected network communication of the in-vehicle infotainment environment comprises:
determining whether the network communication is Wi-Fi communication; and
analyzing additional identification information related to Wi-Fi when the network communication is Wi-Fi communication.

7. The method of claim 6, wherein analyzing the collected network communication of the in-vehicle infotainment environment comprises:
acquiring identification information through a network communication analysis tool including Wireshark.

8. The method of claim 7, wherein identification information acquired by analyzing the collected network communication of the in-vehicle infotainment environment comprises identification information on a connected terminal and identification information on the in-vehicle infotainment system.

9. The method of claim 8, wherein the identification information on the connected terminal comprises at least one of IMEI, ISMI, Model, Vendor, Bluetooth ID, Wi-Fi SSID, Wi-Fi password, used service, used function, used protocol and Port number.

10. The method of claim 8, wherein the identification information on the in-vehicle infotainment system comprises at least one of Model, Vendor, Bluetooth ID, Wi-Fi SSID, Wi-Fi PW, used protocol or Port number.

11. The method of claim 10, wherein deriving the fingerprint of the in-vehicle infotainment environment comprises:
analyzing the identification information on the in-vehicle infotainment system;
analyzing the identification information on the connected terminal;
analyzing service identification information;
analyzing detailed function usage content; and
generating a network fingerprint.

12. The method of claim 11, wherein analyzing the network communication of the in-vehicle infotainment environment based on the derived fingerprint comprises:
inputting network communication data;
comparing and analyzing data based on the network fingerprint;
identifying vehicle type and manufacturer;
identifying the connected terminal and manufacturer of the connected terminal;
identifying used service; and
identifying detailed function usage content.

13. The method of claim 12, wherein:
identification information of the fingerprinted in-vehicle infotainment system comprises at least one of information on category, infotainment system, platform, wireless connection, wireless connection with external device, packet acquisition status, or vehicle data acquisition status, and
identification information of a terminal to be connected to the fingerprinted in-vehicle infotainment system comprises at least one of information on manufacturer, device name, OS and version, or infotainment system.

14. A non-transitory computer-readable storage medium storing one or more programs,
wherein the one or more programs comprise instructions for performing the method of claim 1.

15. An apparatus comprising:
one or more processors; and
a non-transitory computer-readable storage medium storing one or more programs configured to be executed by the one or more processors,
wherein the one or more programs comprise instructions for performing the method of claim 1.
